(19) United States
(12) Patent Application Publication
(10) Pub. No.: US 2017/0083625 A1
(43) Pub. Date: Mar. 23, 2017

(54) METHOD AND SYSTEM FOR PREDICTING POPULARITY OF A CONTENT ITEM

(71) Applicant: YANDEX EUROPE AG, Luzern (CH)

(72) Inventors: Gleb Gennadevich GUSEV, Moscow (RU); Aleksey Valerevich DRUTSA, Moscow (RU); Pavel Viktorovich SERDYUKOV, Moscow (RU)

(21) Appl. No.: 15/262,283

(22) Filed: Sep. 12, 2016

(30) Foreign Application Priority Data
Sep. 23, 2015 (RU) 2015140585

(51) Int. Cl. G06F 17/30; G06N 99/00

(52) U.S. Cl. CPC G06F 17/30867; G06N 99/005; G06F 17/3087

(57) ABSTRACT

There is disclosed a computer-implemented method for predicting content item popularity. The method includes receiving, from a crawler database, an indication of a content item; receiving, from logs, the logs comprising a search log and a browsing log, a search logs data and a browsing logs data, the search logs data representing search activity from one or more users of the search engine server directed to the content item, and the browsing logs data representing browsing activity from one or more users of a browser application directed to the content item; receiving, from the crawler database, a statistical web data representing at least one of embeds or links of the content item contained in one or more web resources directed to the content item; and, predicting the content popularity, based at least in part the search logs data; the browsing logs data; and the statistical web data.

### CROSS-REFERENCE

The present application claims priority to Russian Patent Application No. 2015140585, filed Sep. 23, 2015, entitled “METHOD AND SYSTEM FOR PREDICTING POPULARITY OF A CONTENT ITEM”, the entirety of which is incorporated herein by reference.

### FIELD

The present technology teaches a method of predicting content item popularity.

### BACKGROUND

With the growth of user-generated content items, there has been a constant rise of the number of companies that operate with web content items and not being a host of the content items. In this respect, two types of companies can be identified. The first ones are the organizations that provide a hosting service for user content (content hosting providers). For instance, they are video hosting like Youtube™, music sharing services like Soundcloud™, etc. The second ones (operating companies) are the organizations that operate with user content which is hosted externally at the content hosting providers. Examples of operating companies are web search engine providers (e.g., Yandex™, Google™, Bing™), content aggregators (e.g., Digg™, Reddit™), content recommendation systems (e.g. StumbleUpon™, Pinterest™) etc. Of course, one company may act both as a content hosting provider and operating company. For example, large social networks like Facebook™ and Twitter™ store billions of user messages and, at the same time, they provide the ability to embed external videos and images directly into the messages.

Since operating companies usually deal with tremendous amounts of external content, the challenge of estimating the current and the future popularity (e.g. the number of views, the number of comments received, etc.) of the content item is inevitable for them. It is considered that the predicted current and future values of content popularity can serve as strong features for content ranking and content analysis problems in general. So, a high quality popularity prediction mechanism is an important component of any operating company, which strongly influences the usefulness of the service to its end users.

In some situations, the popularity of the content is disclosed by the content hosting provider through an application programming interface (API); however, in other circumstances it cannot be retrieved from the content hosting provider at all (for example, the API could be simply absent). Meanwhile, even if the API provides the information on popularity, the API could be periodically or permanently unavailable, or could set a limit on the number of allowed requests per time period, which can be insufficient for the operating companies' needs. Besides, the provided API could be delivered with a delay.

Inaccurate content item popularity can cause viewer dissatisfaction when wanting to locate a content item that may be of interest to the user. Further, an inaccurate or misleading content item can increase the repeated searching for the user, consequently resulting in increased battery consumption, and increased consumption of bandwidth.

It is an object of the present technology to ameliorate at least some of the inconveniences present in the prior art.

U.S. Pat. No. 7,801,888 provides a media content search results ranked by popularity. In embodiment(s), a search request for television media content can be initiated by a viewer, and television media content that is relevant to the search request can be identified. The relevant television media content can then be ranked based on a popularity rating such that the relevant television media content can be displayed in an ordered list that is ordered by popularity rankings.

US2013/0311408 relates to processes and systems that may be used to predict which content (e.g., programs, series, movies, channels, etc.) will be popular in the future. The processes and systems may use a model that is trained using historical data reflecting information about past showings of programs, such as rating information, viewer behaviors (e.g., channel changes and DVR recordings), online social activity (e.g., Facebook likes and relevant Twitter messages), and/or other data. Accordingly, it may be possible to provide predictive recommendations of popular content before, for example, the content is scheduled or otherwise planned to be distributed or made available to viewers. The results of such prediction may be integrated with, for example, a program guide available to viewers.

U.S. Pat. No. 8,856,113 relates to a responding to queries for aggregated video and/or audio content that is found embedded in web pages. In particular, this technology relates to ranking of search results and compiling an index against which to search.

U.S. Pat. No. 7,783,632 relates to a ranking system and method that facilitates improving the ranking and ordering of objects to further enhance the quality, accuracy, and delivery of search results in response to a search query. The system and method involve monitoring and tracking an object in terms of the number of times it's been accessed and optionally by whom, when, for how long, and an access rate. The user's interactions with the object can be tracked as well. By tracking the objects, a popularity measure can be determined. Popularity based rankings can be computed based on the popularity measure or some function thereof. The popularity measure can be affected by the access time, who accessed it, access duration or the user's interaction with the object upon access. The popularity based rankings can be utilized by a search component to improve the quality and retrieval of search results.

### SUMMARY

In one aspect, the present technology provides a method for predicting content item popularity, the method executable by a server, the server coupled to a communication network, the communication network having coupled thereto a search engine server and a content hosting server. The method includes receiving, from a crawler database, an indication of a content item; receiving, from a logs, the logs comprising a search log and a browsing log, a search logs data and a browsing logs data, the search logs data representing search activity from one or more users of the search engine server directed to the content item, and the browsing logs data representing browsing activity from one or more users of a browser application directed to the content item; receiving, from the crawler database, a statistical web data representing at least one of embeds or links of the content item contained in one or more web resources directed to the content item; and, predicting a content popularity, based at least in part of (i) the search logs data; (ii) the browsing logs data; and (iii) the statistical web data.

In another broad aspect, the method includes receiving, from the content hosting server via a content hosting service API, a listing of statistical data associated with the static and dynamic features of the content item, the (i) static features comprising features descriptive of the content item that remains independent of user views, and the dynamic features comprising features descriptive of the content item that captures the relationship between the content item and the user interactions; and predicting the content popularity, based at least in part of (i) the search logs data; (ii) the browsing logs data; (iii) the statistical web data, and (iv) the static and dynamic features received via the content hosting service API.

In yet another aspect, the server is implemented as part of the search engine server.

In another aspect, the search logs is implemented as part of the search engine server.

In another aspect, the browsing logs is implemented as part of the search engine server.

In yet another aspect, the content hosting server storing the content hosting web resource hosting the content item has been previously crawled, and the indication of the crawled content hosting web resource is stored in the crawler database.

In a further aspect, the statistical web data representing at least one of embeds or links of the content item contained in one or more web resources has been previously crawled from the web resource server and stored in the crawler database.

In a further aspect, the search logs data includes dynamic-search-logs-features associated with the content item, the dynamic-search-logs-features comprising at least one of:
a number of shows of a content item URL on a search engine result page (SERP);
a number of clicks on the content item URL on the SERP; and,
a click through rate of the content item URL on the SERP.

In a further aspect, the browsing logs data includes dynamic-browsing-logs-features associated with the content item, the dynamic-browsing-logs-features comprising a number of visits of the content item URL registered in the browsing logs.

In yet another aspect, the statistical web data representing at least one of embeds or links of the content item contained in one or more web resources include aggregated-dynamic-web-features associated with the content item, the aggregated-dynamic-web-features including at least one of:
a number of all embeds of the content item;
a number of all hosts with embeds of the content item;
a maximum number of embeds of the content item per host;
an average number of embeds of the content item per host;
a maximum number of embeds of content item per page;
an average number of embeds of content item per page;
a number of days passed since the first embed of the content item;
a number of days passed since the last embed of the content item;
an average number of days passed since any embed of the content item;
a number of all links to the content item;
a number of all hosts with links to the content item;
a maximum number of links to the content item per host;
an average number of links of links to the content item per host;
a number of days passed since the day of the day of a first link;
a number of days passed since the content item was linked last time; and,
an average number of days passed since there was any link to the content item.

In yet another aspect, the statistical web data representing at least one of embeds or links of the content item contained in one or more web resources include non-aggregated-dynamic-web-features associated with the content item, the non-aggregated-dynamic-web-features including at least one of:
a host list with embed timestamps of the content item; and
a host list with link timestamps of the content item.

In a further aspect, the predicting of content popularity is executed using a machine learning algorithm.

In an additional aspect, the machine learning algorithm is using a Friedman's gradient boosting decision trees model.

In a further aspect, the Friedman's gradient boosting decision trees model is receiving an outcome of a linear influence model as an input feature.

In another aspect, the linear influence model is receiving the non-aggregated-dynamic-web-features as an input feature.

In yet another aspect, the machine learning algorithm is trained.

In an additional aspect, the training of the machine learning algorithm is executed continuously in parallel with the prediction of content popularity.

In yet another aspect, the ranking of the content item is based on the determined content popularity prediction.

In another aspect, a server coupled to a communication network, the communication network having coupled thereto a search engine server and a content hosting server is provided. The server includes a communication interface structured and configured to communicate with the search engine server via a communication network, and at least one computer processor operationally connected with a communication interface and structure, configured to; receive, from a crawler database, an indication of a content item; receive, from a logs, the logs comprising a search log and a browsing log, a search logs data and a browsing logs data, the search logs data represents search activity from one or more users of the search engine server directed to the content item, and the browsing logs data represents browsing activity from one or more users of a browser application directed to the content item; receive, from the crawler database, a statistical web data representing at least one of embeds or links of the content item contained in one or more web resources directed to the content item; and, predict a content popularity, based at least in part of (i) the search logs data; (ii) the browsing logs data; and (iii) the statistical web data.

In another broad aspect, the processor is configured to receive, from the content hosting server via a content hosting service API, a listing of information associated with the static and dynamic features of the content item, the (i) static features comprising features descriptive of the content item that remains independent of user views, and the dynamic features comprising features descriptive of the content item that captures the relationship between the content item and the user interactions; and predict the content popularity, based at least in part of (i) the search logs data; (ii) the browsing logs data; (iii) the statistical web data, and (iv) the static and dynamic features received via the content hosting service API.

In yet another aspect, the server is implemented as part of the search engine server.

In another aspect, the search logs is implemented as part of the search engine server.

In another aspect, the browsing logs is implemented as part of the search engine server.

In yet another aspect, the content hosting server storing the content hosting web resource hosting the content item has been previously crawled, and the indication of the crawled content hosting web resource is stored in the crawler database.

In a further aspect, the statistical web data representing at least one of embeds or links of the content item contained in one or more web resources has been previously crawled from the web resource server and stored in the crawler database.

In a further aspect, the search logs data includes dynamic-search-logs-features associated with the content item, the dynamic-search-logs-features comprising at least one of:
a number of shows of a content item URL on a search engine result page (SERP);
a number of clicks on the content item URL on the SERP; and,
a click through rate of the content item URL on the SERP.

In a further aspect, the browsing logs data includes dynamic-browsing-logs-features associated with the content item, the dynamic-browsing-logs-features comprising a number of visits of the content item URL registered in the browsing logs.

In yet another aspect, the statistical web data representing at least one of embeds or links of the content item contained in one or more web resources include aggregated-dynamic-web-features associated with the content item, the aggregated-dynamic-web-features including at least one of:
a number of all embeds of the content item;
a number of all hosts with embeds of the content item;
a maximum number of embeds of the content item per host;
an average number of embeds of the content item per host;
a maximum number of embeds of content item per page;
an average number of embeds of content item per page;
a number of days passed since the first embed of the content item;
a number of days passed since the last embed of the content item;
an average number of days passed since any embed of the content item;
a number of all links to the content item;
a number of all hosts with links to the content item;
a maximum number of links to the content item per host;
an average number of links of links to the content item per host;
a number of days passed since the day of the day of a first link;
a number of days passed since the content item was linked last time; and,
an average number of days passed since there was any link to the content item.

In yet another aspect, the statistical web data representing at least one of embeds or links of the content item contained in one or more web resources include non-aggregated-dynamic-web-features associated with the content item, the non-aggregated-dynamic-web-features including at least one of:
a host list with embed timestamps of the content item; and
a host list with link timestamps of the content item.

In a further aspect, the predicting of content popularity by the processor is executed using a machine learning algorithm.

In an additional aspect, the machine learning algorithm is using a Friedman's gradient boosting decision trees model.

In a further aspect, the Friedman's gradient boosting decision trees model is receiving an outcome of a linear influence model as an input feature.

In another aspect, the linear influence model is receiving the non-aggregated-dynamic-web-features as an input feature.

In yet another aspect, the machine learning algorithm is trained.

In an additional aspect, the training of the machine learning algorithm is executed continuously in parallel with the prediction of content popularity.

In yet another aspect, the ranking of the content item is based on the determined content popularity prediction.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, “electronic device” is associated with a user. Thus, some non-limiting examples, the electronic device may include personal computers (desktops, laptops, netbooks, etc.), smartphones, and tablets, as well as network equipment such as routers, switches, and gateways. It should be understood, that in the present context the fact that the device functions as the electronic device does not mean that it cannot function as a server for other electronic devices. Using of the expression “electronic device” does not mean that several electronic devices may not be involved in receiving/sending, carrying out or causing to be carried out any task or request, or the consequences of any task or request, or any steps of the method, disclosed in the present description.

In the context of the present specification, unless provided expressly otherwise, “content item” refers to any data that is presentable (visually, audibly, or otherwise) by the electronic device 102. Thus, the content item can include written text, images, graphics, animation, video, music, voice, and the like, or any combination thereof. For example, if the content hosting provider is an on-line platform for video-sharing, such as Youtube™, content item may include videos uploaded by individuals or organizations. Similarly, if the content hosting provider is a digital distribution platform for mobile apps, such as App Store™, content item may include apps made available for download by the app's publishers. If the content hosting provider is an online social networking service, such as Twitter™, content item may include the short character messages called “tweets”, published by individuals or organizations. Furthermore, if the content hosting provider is an online news service, such as VICE News™, content item may include the textual information, pictures, and/or video.

### DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a system in accordance with non-limiting embodiments of the present technology for predicting popularity of a content item.

FIG. 2 is a block diagram illustrating an example of a content hosting server according to some non-limiting implementations of the present technology.

FIG. 3 is a block diagram illustrating an example of a web resource server according to some non-limiting implementations of the present technology.

FIG. 4 is a block diagram illustrating an example of the logs according to some non-limiting implementations of the present technology.

FIG. 5 is a block diagram of a popularity prediction server, content hosting service API, logs, and crawler database according to some non-limiting implementations of the present technology.

FIG. 6 is a flow diagram of an exemplary method for predicting popularity of a content item.

### DETAILED DESCRIPTION

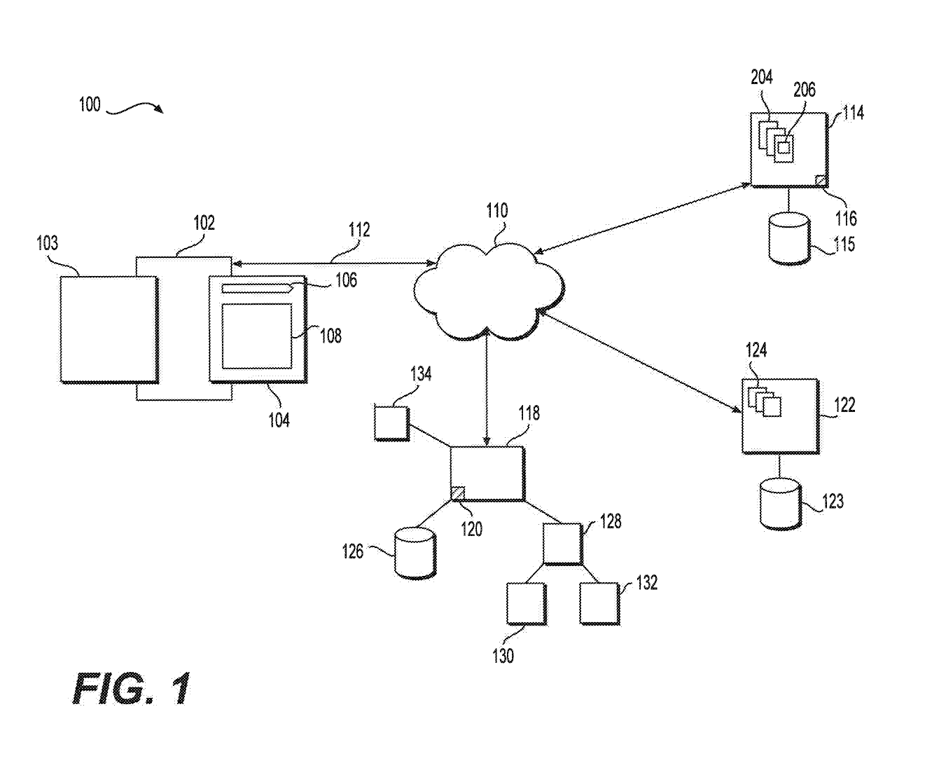

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not mean to suggest or imply any mode of operation—such as a need to log in, a need to be registered or the like.

In the context of the present specification, unless provided expressly otherwise, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 comprises hardware and/or software and/or firmware (or a combination thereof), as is known in the art, to execute a browser application 103. Generally speaking, the purpose of the browser application 103 is to enable the user to access one or more web resources 124 and/or content hosting web resources 204. The manner in which content hosting web resources 204 are implemented is not limited, and may correspond to a web platform on which a content item 206 (described below) can be posted. Generally speaking the content hosting web resources 204 are stored in a content hosting server 114 which is managed by a content hosting provider (not depicted), such as Youtube™. On the other hand, how the one or more web resources 124 are implemented is not limited, and may correspond to a web platform on which the content item 206 hosted on the content hosting web resources 204 is susceptible of being “re-posted” on.

How the browser application 103 is implemented is not particularly limited. One example of the browser application 103 may be embodied as a Yandex.Browser™. How the browser application 103 is implemented is generally known in the art and as such, will not be described here at much length.

The electronic device 102 also comprises hardware and/or software and/or firmware (or a combination thereof), as is known in the art, to execute a search application 104. Generally speaking, the purpose of the search application 104 is to enable the user to execute a search on the web. To that end, the search application 104 comprises a query interface 106 and search results interface 108.

How the search application 104 is implemented is not particularly limited. One example of the search application 104 may be embodied in a user accessing a web site associated with a search engine to access the search application 104. For example, the search application can be accessed by typing in an URL associated with Yandex™ search engine at www.yandex.ru. It should expressly be understood that the search application 104 can be accessed using any other commercially available or proprietary search engine.

Generally speaking, the search application 104 is configured to receive from the user a query, for example a “search string” and to provide search results that are responsive to the query. Briefly speaking, the query is transferred to a search engine server 118 (described below) over a communication network 110 (described below), and the search engine server 118 will carry out the query, or causing the query to be carried out.

The electronic device 102 is coupled to the communication network 110 via a communication link 112. In some non-limiting embodiments of the present technology, the communication network 110 can be implemented as the Internet. In other embodiments of the present technology, the communication network 110 can be implemented differently, such as any wide-area communications network, local-area communications network, a private communications network and the like.

How the communication link 112 is implemented is not particularly limited and will depend on how the electronic device 102 is implemented. Merely as an example and not as a limitation, in those embodiments of the present technology where the electronic device 102 is implemented as a wireless communication device (such as a smart-phone), the communication link 112 can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the electronic device 102, the communication link 112 and the communication network 110 are provided for illustration purposes only. As such, those skilled in the art will easily appreciate other specific implementational details for the electronic device 102. As such, by no means, examples provided herein above are meant to limit the scope of the present technology.

Also coupled to the communication network 110 is a content hosting server 114. The content hosting server 114 can be implemented as a conventional computer server. In an example of an embodiment of the present technology, the content hosting server 114 can be implemented as a Dell™ PowerEdge^{TN} Server running the Microsoft™ Windows Server™ operating system. Needless to say, the content hosting server can be implemented in any other suitable hardware and/or software and/or firmware or a combination thereof. In the depicted non-limiting embodiment of present technology, the content hosting server 114 is a single server. In alternative non-limiting embodiments of the present technology, the functionality of the content hosting server 114 may be distributed and may be implemented via multiple servers.

In some embodiments of the present technology and generally speaking, the content hosting server 114 is under control and/or management of a content hosting provider (not depicted), such as, for example, an operator of Youtube™, Vimeo™, Soundcloud™, iTunes™, App Store™, Amazon™ just to name a few.

In some embodiments, the content hosting server 114 comprises one or more databases 115 which functions to store content hosting web resources 204 (described below) which may be delivered and displayed on the electronic device 102. The content hosting web resources 204 (explained below) hosts at least one content item 206 (explained below) and are accessible by the electronic device 102 via the communication network 110, for example, by means of typing in an URL or executing a web search using the search application 104. Generally, speaking, each content item has a server-assigned filename that uniquely identifies the file in the database 115. Each database 115 includes, for each stored content items, indexing data by which each content items can be identified and selectively retrieved from the database upon request by, for example, the electronic device 102.

Although the database 115 is depicted as separate from the content hosting server 114 to which it is coupled to via a dedicated link (not numbered), the database 115 can be implemented as being part of the content hosting server 114.

In the context of the present specification, “content item” refers to any data that is presentable (visually, audibly, or otherwise) by the electronic device 102. Thus, the content item can include written text, images, graphics, animation, video, music, voice, and the like, or any combination thereof. As described previously, the content hosting server 114 on which the content item is stored is under control and/or management of a content hosting provider (not depicted). For example, if the content hosting provider is an on-line platform for video-sharing, such as Youtube™, content item may include videos uploaded by individuals or organizations. Similarly, if the content hosting provider is a digital distribution platform for mobile apps, such as App Store™, content item may include apps made available for download by the app's publishers. If the content hosting provider is an online social networking service, such as Twitter™, content item may include the short character messages called “tweets”, published by individuals or organizations. Furthermore, if the content hosting provider is an online news service, such as VICE News™, content item may include the textual information, pictures, and/or video.

Furthermore, in some embodiments, the content hosting server 114 may host one or more web services that provides one or more libraries of application program interfaces (API) (“content hosting service API 116”). How the content hosting service API 116 is implemented is generally known in the art and as such, will not be described here at much length. Suffice to say that upon request, for example, by a popularity prediction server 134 (described below), the content hosting service API 116 provides a listing of statistical data associated to a particular content item contained in the database 115. Generally speaking, the data associated to a particular content item relates to the static and dynamic features of the content item (described below).

Also coupled to the communication network 110 is the search engine server 118. Suffice to say that the search engine server 118 can be implemented in a similar manner to the content hosting server 114. Generally speaking, the search engine server 118 is under control and/or management of a search engine provider (not depicted), such as, for example, an operator of the Yandex™ search engine. As such, the search engine server 118 may be configured to execute one or more searches responsive to the “search string” entered by the user into the query interface 106. The search engine server 118 is also configured to transmit to the electronic device 102 a set of search results, to be displayed to the user via the search results interface 108.

The search engine server 118 is also configured to execute a crawling function and, to that end, comprises a crawler application 120. Although the crawler application 120 is depicted as being comprised within the search engine server 118, it is not limited as such. Generally speaking, the crawler application 120 is configured to access the content hosting server 114 to identify and retrieve content hosting web resources 204 (explained below). For example, and not as a limitation, the crawler application 120 regularly crawls the RSS feeds of the content hosting server 114 to identify and retrieve new content items.

The crawling by the crawler application 120 is not limited only to the content hosting web resources 204 hosted in the content hosting server 114, and can also include the web resources 124 (explained below) hosted by a web resource server 122.

Within the system 100, there is the web resource server 122 connected to the communication network 110 via a dedicated link (not numbered). Much akin to the search engine server 118, the web resource server 122 can be implemented in a similar manner to the content hosting server 114. Additionally, although depicted only as one server, the web resource server 122 can be a plurality of web resource servers.

In some embodiments, the web resource server 122 comprises one or more databases 123 which function to store data indicative of web resources 124 being accessible by the electronic device 102 via the communication network 110. Generally speaking the web resources 124 can be accessed by the electronic device 102 by means of typing in/copying/clicking an URL or executing a web search using the search application 104. Although depicted as separate from the web resource server 122 and coupled to via a dedicated link (not numbered), the database 123 can be implemented as part of the web resource server 122.

In some embodiments and generally speaking, the crawler application 120 is configured to access the web resource server 122 to identify and retrieve one or more web resources 124.

Suffice it to say for now that, an indication of the crawled objects are indexed and stored in the crawler database 126. Although depicted as separate of the search engine server 118 to which it is coupled to via a dedicated link (not numbered), the crawler database 126 can be implemented as part of the search engine server 118. Generally speaking, the crawler database 126 also contains records for each crawled object, where the record can include data such as the date of the last access or crawling, which may be used by the crawler application 120 to keep the crawler database 126 up-to-date, and which can further reduce or eliminate duplicates.

The search engine server 118 has access to logs 128 via a link (not numbered). Broadly speaking, the logs 128 can store data associated with a user's network interaction via the browser application 103 and the search application 104. In some non-limiting embodiments of the present technology, the logs 128 are connected via dedicated links (not depicted) to two kinds of logs: a search log 130 and a browsing log 132. Generally speaking, the “search strings”, which one or more users input to the search application 104, as well as search action data of the users are stored in the search logs 130, and the browsing logs 132 store the indication of the web content browsed by the user using the browser application 103.

Although the search logs 130 and browsing logs 132 are depicted as separate entities from the logs 128 and the search engine server 118, it is possible to implement the search logs 130 and browsing logs 132 as part of the search engine server 118 and/or logs 128.

The search engine server 118 is also coupled to a popularity prediction server 134. Suffice to say that the popularity prediction server 134 can be implemented in a similar manner to the content hosting server 114. In the depicted non-limiting embodiment of the present technology, the popularity prediction server 134 is a single server. In alternative non-limiting embodiments of the present technology, the functionality of the popularity prediction server 134 may be distributed and may be implemented via multiple servers. Furthermore, although in the depicted embodiment, the popularity prediction server 134 is depicted as being separate from the search engine server 118, it is not limited so, and may be implemented as part of the search engine server 118.

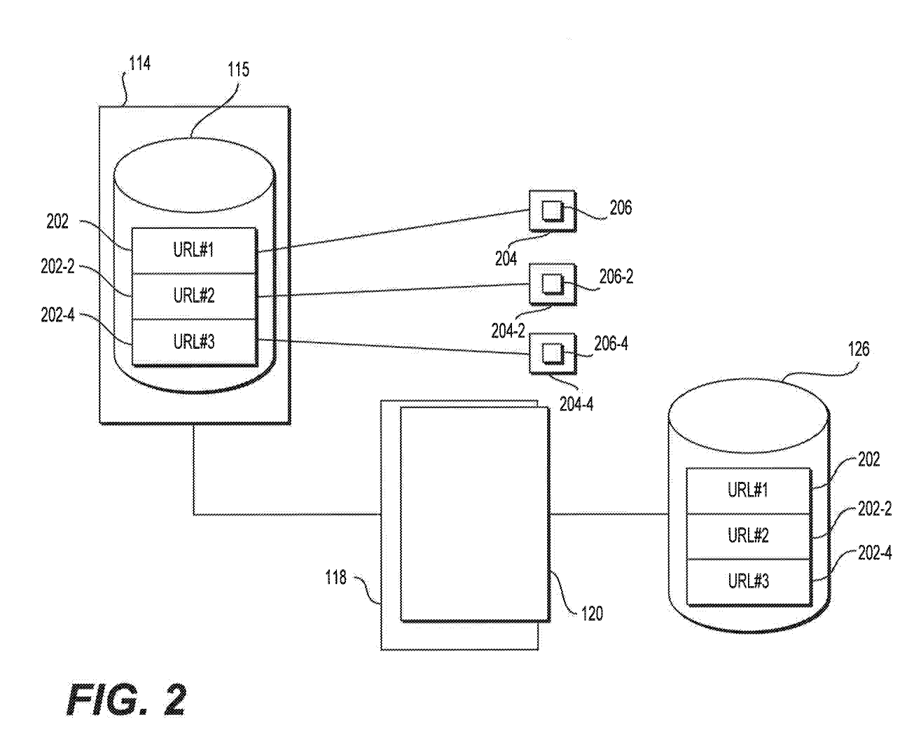

FIG. 2 is a schematic diagram specifically demonstrating an architecture 200 illustrating an example of the content hosting server 114 according to some implementations. The content hosting server 114 generally functions to serve as a repository for a plurality of content hosting web resources 204, 204-2 and 204-4 by storing them in the database 115.

In some non-limiting embodiments of the present technology, the database 115 comprises a list of identifiers, such as URLs (depicted as URL#1 202, URL#2 202-2, and URL#3 202-4) which corresponds to the content hosting web resources 204, 204-2, 204-4, respectively.

Each of the content hosting web resources 204, 204-2, 204-4 contains one or more content items 206, 206-2, 206-4 respectively. As explained previously, content items 206, 206-2, 206-4 can include written text, images, graphics, animation, video, music, voice, and the like, or any combination thereof.

Generally speaking, as a user of the content hosting service uploads (or posts) new content items on the web, a new content hosting web resource having a unique URL is generated, and the URL is stored in the database 115. For example, if a user posts a new video on YouTube™, a content hosting web resource having a unique URL and containing the video will be generated, and its URL will be stored in the database 115.

Thus, although the database 115 is depicted as containing only three URLs (URL#1 202, URL#2 202-2, and URL#3 202-4), it is not limited as such, and may contain a plurality of URLs corresponding to the existing content hosting web resources.

Also depicted in FIG. 2 is the search engine server 118 comprising the crawler application 120. As discussed briefly previously, the crawler application 120 is configured to periodically access the content hosting server 114 to identify and retrieve content items 206, 206-2, and 206-4. The crawler application is then configured to create an index of the crawled content items 206, 206-2, 206-4 in the crawler database 126. For example, as depicted in FIG. 2, the crawler database 126 contains the indication of the content items 206, 206-2, 206-4, such as the URL of the content hosting web resources 204, 204-2, and 204-4.

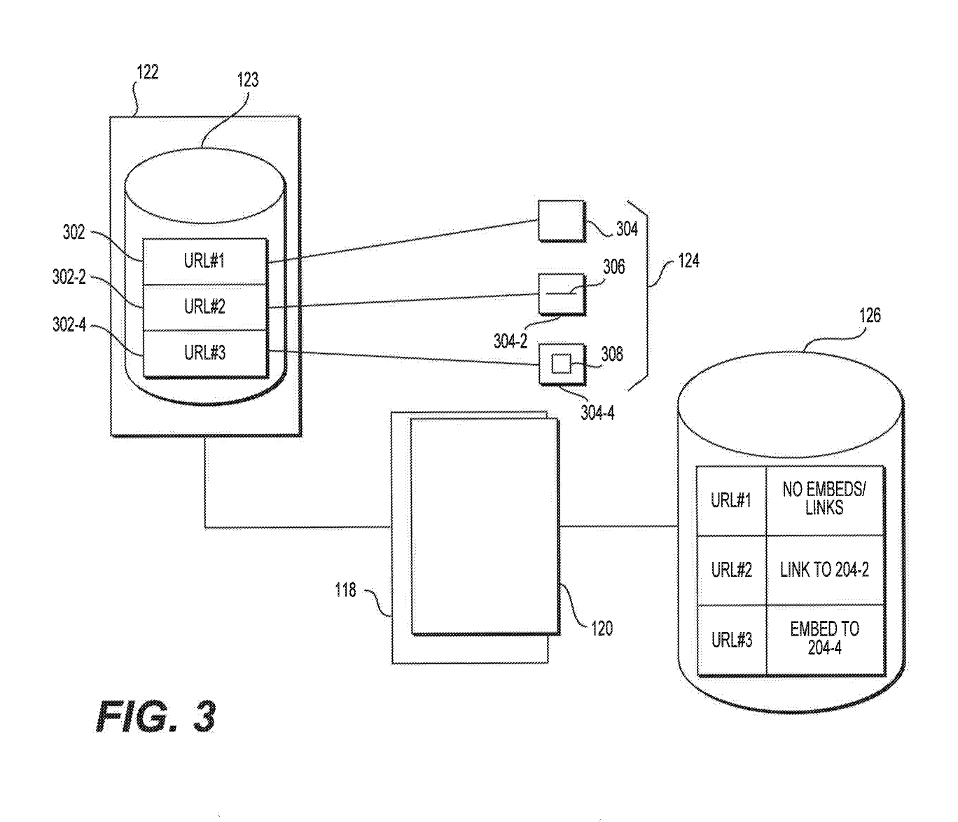

FIG. 3 is a schematic diagram specifically demonstrating an architecture 300 illustrating an example of the web resource server 122 according to some implementations. Web resource server 122 generally functions to serve as a repository for a plurality of web resources 124 (individual web resources renumbered as 304, 304-2, 304-4) by storing them into the database 123.

In some non-limiting embodiments of the present technology, the database 123 comprises of a list of identifiers, such as URLs (depicted as URL#1 302, URL#2 302-2, and URL#3 302-4) which corresponds to the URLs of the web resources (304, 304-2, 304-4 respectively). The manner in which web resources 304, 304-2 and 304-4 are implemented is not limited, and may correspond to a web resource belonging to a variety of web platforms on which the content items 206, 206-2, 206-4 is susceptible of being “re-posted” on. For example, web resources 304, 304-2, 304-4 can include web resources being operated by entertainment news services (such as BuzzFeed™), social networking services (such as Reddit™, 9GAG™), blogging services (such as WordPress™), and the like, or any combination thereof.

Generally speaking, as a user of the web service uploads (or posts) on the web service a new web resource, a unique URL is generated for that web resource, which is stored in the database 123. For example, if a user of a blogging service posts on a daily basis different blog posts, each will have a different URL, and each of its URLs will be stored in the database 123. However, this is not always the case. For example, in a web resource hosting a “threaded discussion” amongst a plurality of users (such as for example, Reddit™, or the “comments” section of a blog in WordPress™ or the like) the posts of each users merely change the content of the web resource, but do not generate a new web resource.

Thus, although the database 123 is depicted as containing only three URLs (URL#1 302, URL#2 302-2, and URL#3 302-4), it is not limited as such, and may contain a plurality of URLs of the existing web resources 124.

In some non-limiting embodiments of the present technology, one or more of the web resources 124 can contain a link or embed, or a combination thereof, directed to the content hosting web resources 204, 204-2, and 204-4. For example, the web resource 304-2 contains a link 306 to content hosting web resource 204-2, which hosts content item 206-2. In another non-limiting embodiment of the present technology, web resource 304-4 contains an embed 308 corresponding to the content item 206-4, which is hosted in the content hosting web resource 204-4.

Also depicted in FIG. 3 is the search engine server 118 comprising the crawler application 120. Similar to the crawler application 120 described in FIG. 2, the crawler application 120 is configured to the web resource server 122 to identify and retrieve web resources 304, 304-2, and 304-4. The crawler is then configured to create an index of the crawled web resources 304, 304-2, 304-4 in the crawler database 126. For example, the crawler application 120 periodically accesses the database 123 to identify and extract web resources 124 by accessing the URLs contained in the database 123, or to update previously crawled web resources 124, and store an indication of the crawled web resources 124 in the crawler database 126.

In some non-limiting aspects of the present technology, the crawler application 120, in the process of storing the extracted web resources 124, extracts text, metadata, or other type of data contained in the content items 206, 206-2, 206-4. Thus, the crawler application 120 identifies any URLs (e.g., hyperlinks 306) contained in the crawled web resources 124, or embeds 308 contained therein. For example, as depicted in FIG. 3, the database 123 contains a listing of the URLs of the crawled web resources 124, namely URL#1 302, URL#2 302-2, and URL#3 302-4. Next to each of the URLs, the database 123 also contains data about any links or embeds contained in the respective URLs. For example, since web resource 304 does not contain any links or embeds, the database 123 does not associate it with any content hosting web resources 204, 204-2, and 204-4. As for the web resource 304-2, since it contains a link 306 directed at content hosting web resource 204-2, the database 123 contains the indication that the URL#2 302-2 contains a link to the content hosting web resource 204-2. In a further example, the web resource 304-4 contains an embed 308 directed at content item 206-4 hosted by the content hosting web resource 204-4, and thus the database 123 contains the indication that the URL#3 302-4 contains an embed to a content item 206-4 content hosting web resource 204-4.

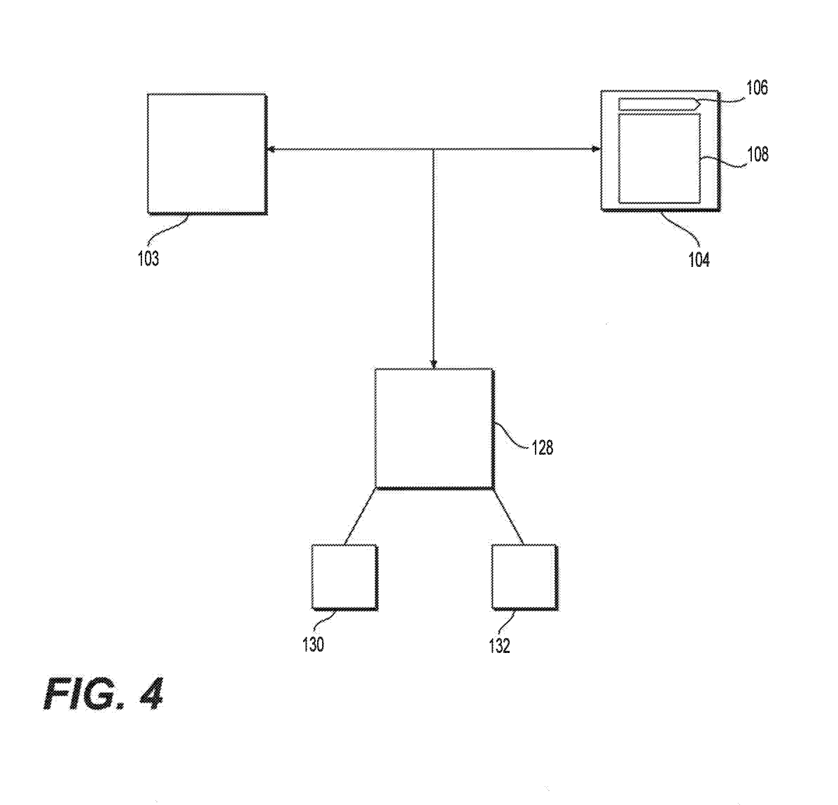

FIG. 4 is a schematic diagram specifically demonstrating an architecture 400 illustrating an example of the logs 128 according to some implementations of the present technology. Logs 128 generally function to gather search activities and browsing activities of the user using the electronic device 102 on the web. More particularly, browsing activities, colloquially referred to as browsing history, of a user using the browser application 103 is stored in the browsing logs 132, whereas search activities, colloquially referred to as search history, of a user using the search application 104 is stored in the search logs 130.

Generally speaking, the manner in which the browsing activity of the user is collected into the browsing logs 132 is not limited. For example, the browsing activities may be obtained from various sources, such as from mining browser logs of the user devices, or other user-provided information. Furthermore, users of the browser application 103 may consent to having their browsing history data provided to the browsing logs 132. Accordingly, a large number of users' browsing activity can be obtained from the browser application 103 and stored in the browsing logs 132. The manner in which the browser application 103 transfers the browsing activity data is not limited, and as such can be transmitted via a dedicated link (not numbered) as depicted, or via the communication network 110.

Generally speaking, unlike the browsing history which is initially stored in the browser application 103, the search history is stored in a remote database operated by the search engine provider, such as the search logs 130. The searches conducted using, for example, but not limited to the “search string” and the outcomes, by the user of the search application 104 are logged by the search application 104 into the search logs 130. The manner in which the search application 104 transfers the search activity data is not limited, and as such can be transmitted via a dedicated link (not numbered) as depicted, or via the communication network.

Although the logs 128, search logs 130 and browsing logs 132 are depicted as separate entities connected via a dedicated link, it is not limited as such, and can comprise one single entity.

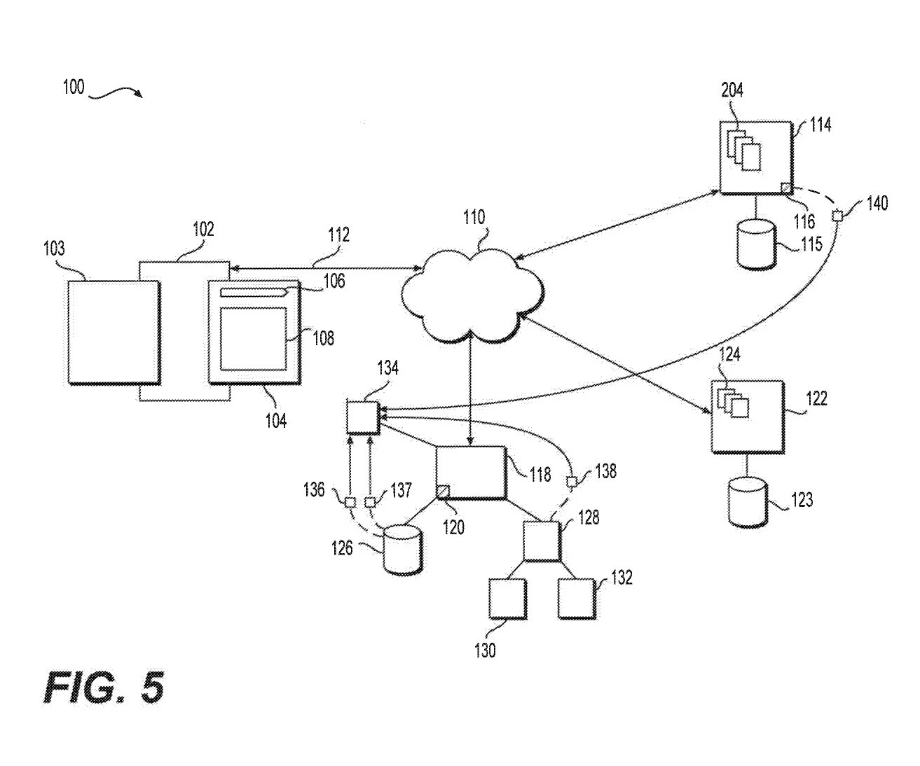

FIG. 5 is a schematic diagram specifically demonstrating an architecture 500 illustrating a an example of the popularity prediction server 134, content hosting service API 116, logs 128, and crawler database 126 according to an embodiment of the present technology. The popularity prediction server 134 cooperates with content hosting service API 116, logs 128, and crawler database 126 to predict the content item popularity.

In some non-limiting embodiments of the present technology, the crawler database 126 transmits a data packet 136 which contains the indication (such as the URL), for example, of the content hosting web resource 204 which hosts the content item 206.

The crawler database 126 also transmits a data packet 137 which contains statistical web data with regards to the content item 206. Remembering that the crawler application 120 extracts text, metadata or other type of data reflecting the content of the crawled web resources 124, the data packet 137 comprises statistical information of links and embeds available on the web directed to, for example, the content item 206.

In some non-limiting aspects of the present technology, the logs 128, which is comprised of search logs 130 and browsing logs 132, transmit a data packet 138 to the popularity prediction server 134, wherein the data packet 138 comprises search and browsing activities of one or more users.

In another broad aspect of the present technology, the content hosting service API 116 transmits a data packet 140 to the popularity prediction server 134. The data packet 140 comprises statistical data collected by the content hosting provider with regards to, for example, the content item 206.

Based at least on the received data packet 136, 137 and 138, the popularity prediction server 134 can be implemented with a machine learning algorithm to estimate a popularity prediction parameter of, for example, the content item 206. In another broad aspect of the present technology, based at least on the data packet 136, 137, 138 and 140, the popularity prediction server 134 can be implemented with the machine learning algorithm to estimate the popularity prediction parameter of, for example, the content item 206.

Estimation of the Popularity Prediction Parameter

Generally speaking, the popularity prediction parameter represents a prediction of the total number of views of the given content item at a given point of time.

The popularity prediction server 134 determines the popularity prediction parameter after the indication of, for example, the content item 206, has received from the crawler database 126. The machine learning algorithm utilized by the popularity prediction server 134 is trained (will be explained below) to predict the share of total views that will happen within a given point of time.

Prediction of Content Item Popularity Using a Machine Learning Algorithm

In some non-limiting embodiments of the present technology, in order for the popularity prediction server 134 to predict the popularity parameter of a content item, the machine learning algorithm can be used.

The machine learning algorithm utilized by the popularity prediction server 134 is trained to predict the popularity of the content item, using a combination of a Friedman's gradient boosting decision trees model and a linear influence model.

As will be explained below, the machine learning algorithm requires a set of features associated with, for example, the content item 206, to execute the prediction of the popularity parameter.

As is known to those skilled in the art, in order for the machine learning algorithm to predict popularity, it must first be “trained” with a set of training data.

In some non-limiting embodiments of the present technology, the training data can comprise of: a) the data packet 136, provided by the crawler database 126, which contains the indication (such as the URL), for example, of the content hosting web resources 204, 204-2, and 204-6 which host the content items 206, 206-2, and 206-4; b) the data packet 137, provided by the crawler database 126, representing statistical web data associated with the content item, wherein such web data include at least one of embeds or links to the content hosting web resources 204, 204-2, and 204-4; and c) the data packet 138, provided by the logs 128, representing indications of search actions of users, and content browsed by the users, associated with the content item.

In another broad embodiment of the present technology, the training data can include an additional set of training data, the data packet 140, provided by the content hosting service API 116, representing the listing of statistical data associated to a particular content item collected by the content hosting provider, such as the static and dynamic features of the content item (described below).

A detailed explanation of the data packet 136, 137, 138, and 140 is provided below.

Data packet 140—As explained previously, the data packet 140 is received from the content hosting service API 116, and comprises of statistical data with regards to the content items 206, 206-2, 206-4 hosted in the content hosting web resources 204, 204-2, 204-6 stored in the database 115.

In some non-limiting embodiments of the present technology, the data contained in the data packet 140 can be divided into two types of data. The first type of data relates to a set of static features of the respective content items 206, 206-2, and 206-4. The second type of data relates to a set of dynamic features of the content respective content items 206, 206-2, and 206-4.

Broadly speaking, a “static” feature refers to a feature descriptive of the content items 206, 206-2, and 206-4 that remains independent with user views. The list of the static features is non-exhaustive. Some examples of the features may include:
Content item duration in seconds;
Content item category;
Content item title length in number of characters;
Day of the week of the content item upload date;
The hour of the content item upload time;
The author's age in number of days from her or his registration date;
The number of content items uploaded by the author;
The total time in seconds that viewers viewed all the author's content items;
The number of the author's friends; and,
The number of the author's subscribers.

Broadly speaking, a “dynamic” feature refers to a feature descriptive of the content items 206, 206-2, and 206-4 that captures the relationship between the content items 206, 206-2, and 206-4 and user interactions. The list of the dynamic features is also non-exhaustive. Some examples of the features may include:
The number of comments on the content item;
The number of likes of the content item;
The number of dislikes of the content item;
The minimum rating assigned to the content item;
The maximum rating assigned to the content item;
The average rating assigned to the content item; and,
The number of days passed from the last update date.

Data packet 138—As explained previously, the data packet 138 is received from the logs 128.

In some non-limiting aspect of the present technology, the data packet 138 can be divided into two types of data. The first type of data, originally stored in the search logs 130, comprises of the dynamic features from the search logs 130 (“dynamic-search-logs-features”), which relates to the search activities of a user using the search application 104. The second type of data, originally stored in the browsing logs 132, comprises of the dynamic features from the browsing logs 132 (“dynamic-browsing-logs-features”), which relates to browsing activities of a user using the browser application 103.

The list of the dynamic-search-logs-features is non-exhaustive. Some examples of the dynamic-search-logs-features may include:
The number of shows of the content item URLs on the search engine result page (SERP);
The number of clicks on the content item URLs on the SERP; and,
The click through rate of the content item URLs on the SERP.

The list of the dynamic-browsing-logs-features is non-exhaustive. Some examples of the dynamic-browsing-logs-features may include the number of visits of the content URLs registered in the browsing logs 132.

Data packet 137—As explained previously, the data packet 137 is received by the crawler database 126, which comprises of statistical information of links and embeds available on the web directed to the content items 206, 206-2, 206-4.

In some non-limiting aspect of the present technology, features from the publicly available resources of the web resources 124 were split into aggregated features (“aggregated-dynamic-web-features”) and non-aggregated features (“non-aggregated-dynamic-web-features”). Briefly speaking, the aggregated feature is a feature that aggregates the information about a number of elementary features, that are called non-aggregated features. For instance, each web site (host) is an elementary non-aggregated feature, which has data about the content item. Usually, because of their large number, such features are aggregated in a small number of features with each of them representing some aspect of the content item.

The list of the aggregated-dynamic-web-features is non-exhaustive. Some examples of the aggregated-dynamic-web-features may include:
the number of all embeds of the content item;
the number of all hosts with embeds of the content item;
the maximum number of embeds of the content item per host;
the average number of embeds of the content item per host;
the maximum number of embeds of content items per page;
the average number of embeds of content items per page;
the number of days passed since the first embed of the content item;
the number of days passed since the last embed of the content item;
the average number of days passed since any embed of the content item:
the number of all links to the content item;
the number of all hosts with links to the content item;
the maximum number of links to the content item per host;
the average number of links of links to the content item per host;
the number of days passed since the day of the day of the first link;
the number of days passed since the content item was linked last time; and
the average number of days passed since there was any link to the content item;

The list of the non-aggregated-dynamic-web-features is non-exhaustive. Some examples of the non-aggregated-dynamic-web-features may include:
The host list with embed timestamps of the content item; and,
The host list with link timestamps of the content item.

Data packet 136—As explained previously, the data packet 136 is received from the crawler database 126, and contains the indication (such as the URL), for example, of the content hosting web resources 204, 204-2, and 204-6 which host the content items 206, 206-2, and 206-4. In some non-limiting embodiments, the crawler application 120 regularly crawls the content hosting server 114's RSS feeds of available content items, and store the indication, such as the URL, of the content hosting web resources 204, 204-2 and 204-4 in the crawler database 126.

Methodology for Modelling a Machine Learning Algorithm

First, a harvest time period is defined. For each day in this period, the popularity prediction server 134 receives a data packet 136 from the crawler database 126. As explained previously, the data packet 136 contains the indication (such as the URL), for example, of the content hosting web resources 204, 204-2, and 204-4, which hosts the content items 206, 206-2, and 206-6 respectively.

In another broad aspect of the present technology, at the end of each day, the data packet 140 is received from the content hosting service API 116.

When the harvest time period is over, the data packets 137 and 138 are received.

Using the various data packets, the machine learning algorithm of the popularity prediction server 134 is trained to predict the popularity of a content item hosted by the content hosting server 114. Suffice to say that in some non-limiting embodiments, the different features received are used as the training dataset for a Friedman's gradient boosting decision trees model. In another non-limiting embodiment, the non-aggregated-dynamic-features are used as the training dataset for a linear influence model. In a further non-limiting embodiment, the outcome of the linear influence model may be used as an input feature in the Friedman's gradient boosting decision trees model.

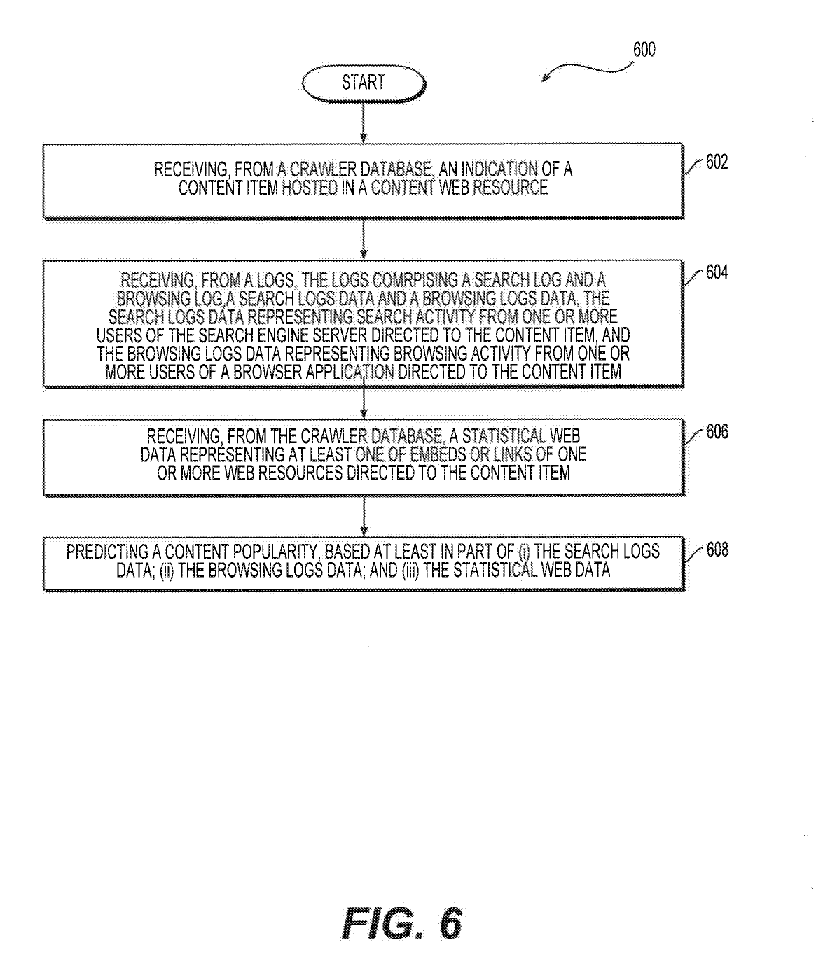

FIG. 6 is a method 600 for predicting content popularity, according to an embodiment of the present technology. Method 600 may correspond to various aspects of operation of popularity prediction server 134. It should be noted that some steps of the method 600 may be executed in parallel or in a different sequence and that the flowchart depicted in FIG. 6 is merely for illustration purposes only

Step 602—Receiving, From a Crawler Database, an Indication of a Content Item Hosted in a Content Hosting Web Resource;

The method starts at step 602, where the popularity prediction server 134 receives, from the crawler database 126, the indication of the content item. The step 602 is executed in response to the crawler application 120 crawling the content hosting server 114 to retrieve newly uploaded content item and indexing it in the crawler database 126. The step 602 can also be executed in response to the determination that the popularity prediction for the content item stored in the crawler database 126 has not been executed yet.

The method 600 will be explained below with reference to one scenario, corresponding to the content item 206. It should be understood that the scenario presented herein below are for illustration purposes only, and the present technology is in no way to be limited based on the scenario presented below.

Scenario 1: A user uploads the content item 206 (FIG. 2) using a content hosting service. The content hosting web resource 204 hosting the content item 206 is generated. The database 115 is updated to include the indication of the content hosting web resource 204, such as URL #1 202. For the purpose of the scenario, the content item 206 is a video of a hyperactive cat jumping around in a hat, and is entitled “Party cat in a hat” by the uploader. The indication of the content item 206 is determined to be http://www.example.com/party-cat-in-a-hat.

The crawling application 120, which regularly crawls the content hosting web resources 204 hosted in the content hosting server 114 via database 115, retrieves the URL http://www.example.com/party-cat-in-a-hat, and stores it in the crawler database 126. The crawler database 126 then transmits the data packet 136 to the popularity prediction server 134, which contains the indication of the content item 206 (such as the URL #1 202).

Step 604—Receiving, From a Logs, the Logs Comprising a Search Log and a Browsing Log, a Search Logs Data and a Browsing Logs Data, the Search Logs Data Representing Search Activity from One or More Users of the Search Engine Server Directed to the Content Item, and the Browsing Logs Data Representing Browsing Activity From One or More Users of a Browser Application Directed to the Content Item;

At step 604, the popularity prediction server 134 receives, from the logs 128, a search logs data and a browsing logs data. The search logs data represents the searches conducted by the one or more users, directed at the content item 206, using the search application 104 which are logged by the search application 104 into the search logs 130. The browsing logs data represent browsing history, directed at the content item 206, using the browser application 103, which are logged initially in the browser application 103, and transmitted to browsing logs 132. Again, the collection of the browsing history by the browser application 103 into the browsing logs 132 is not limited, and may be user-provided.

The step 604 is executed in response to the popularity prediction server 134 receiving the data packet 136. Needless to say, the search logs 130, which comprises of the logs data, and the browsing logs 132, can be implemented separately from the logs 128. That is to say the popularity prediction server 134 can receive respective data from each of the search logs 130 and browsing logs 132 without the use of the logs 128.

Scenario 1: As the content item 206 is made available on the web, a plurality of users have now access to the content item 206 by accessing the URL http://www.example.com/party-cat-in-a-hat (provided the content item 206 is public). Generally speaking, the plurality of users can access the content item 206 by directly typing the URL address http://www.example.com/party-cat-in-a-hat into the URL bar of the browser application 103 or, by performing a search on the search application 104 by using a “search strings”, such as “video, party cat in a hat”.

The logs 128 transmit the data packet 138 to the popularity prediction server 134. The data packet 138 comprises of two type of data: i) the search logs data related to the “search strings” inputted by the plurality of users of the search application 104, such as the content of the SERP displayed as a result to the response of the “search query”, and; ii) the browsing logs data related to the browsing history of the plurality of users using the browser application 103.

Needless to say, the plurality of the data contained in the data packet 138 is directed to the content item 206. More precisely, the search logs data transmitted via the data packet 136 relates, inter alia, to the indication of the content item 206, such as the number of shows of the URL http://www.example.com/party-cat-in-a-hat on the SERP, the URL being a responsive resource for the user queries. Moreover, the browsing logs data transmitted via the data packet 138 also relates to the indication of the content item 206, such as the number of visits of the URL http://www.example.com/party-cat-in-a-hat.

Step 606—Receiving, From the Crawler Database, a Statistical Web Data Representing at Least One of Embeds or Links of One or More Web Resources Directed to the Content Item;

At step 606, the popularity prediction server 134 receives, from the crawler database 126, a statistical web data related to links and embeds available on the web (i.e. data packet 137), which is directed to the indication of the content item 206, such as the URL #1 202.

Scenario 1: As the content item 206 is publicly accessible over the web, a plurality of users finding the video interesting may share the video over the web in the days following the initial uploading. For example, a user having his own animal-friendly blog may publish a new entry on the web resource 304-2 with a link to http://www.example.com/party-cat-in-a-hat, allowing thus his readers to click on the link and access directly the content hosting web resource 204 to view the video. On the other hand, a journalist of a cat-friendly news service may publish a news article on the web resource 304-4 with the video embedded, allowing thus readers to directly view the content item 206 without being redirected to the content hosting web resource 204.

As the web resources 304-2 and 304-4 are generated, they are stored in the web resource server 122 via the database 123. As mentioned previously, the crawler application 120 periodically accesses the database 123 to identify and store extracted text, metadata, or other type of data reflecting the indication of the content item 206, namely the URLs http://www.example.com/party-cat-in-a-hat.

The crawler database 126 transmits to the popularity prediction server 134 the data packet 137, which comprises of web data related to the links or embeds directed available on the web, and directed to http://www.example.com/party-cat-in-a-hat.

Step 608—Predicting a Content Popularity, Based at Least in Part of (i) the Search Logs Data; (ii) the Browsing Logs Data; and (iii) the Statistical Web Data.

Finally, at step 608, based at least in part of (i) the search logs data; (ii) the browsing logs data; and (iii) the statistical web data, the popularity prediction server 134 predicts a content popularity of the content item.

Scenario 1: Using the data received from the data packets 137 and 138, the machine learning algorithm of the popularity prediction server 134 generates a popularity prediction parameter of the content item 206.

The method 600 then terminates.

Optional Enhancements of the Method 600

In another broad embodiment of the present technology, the popularity prediction server 134 can also receive the data packet 140 from the content hosting service API 116, which comprises of statistical data collected by the content hosting provider with regards to the content item 206. In some non-limiting embodiment, the machine learning algorithm of the popularity prediction server 134 is configured to generate a popularity prediction parameter, using the data received from the data packets, 137, 138 and 140, of the content item 206.

One of the main applications of content popularity parameter prediction is the proper ranking of the content items by their popularity. For instance, it allows the operating company to show the most popular content items on the main page, which always attracts a large share of user traffic.

In some embodiments of the present technology, in parallel to the execution of method 600, the popularity prediction server 134 can continuously gather the various features presented above and improve the machine learning algorithm presented hereby.

It should be expressly understood that other methods for improving content popularity prediction can be used. Those skilled in the art, having benefitted from the teachings of the present technology, will be able to select a proper content popularity prediction algorithms that takes into the account the logs and web features as has been disclosed in accordance with embodiments of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

Embodiments of the present technology can be summarized as follows, expressed in numbered clauses.

CLAUSE 1. A method (600) for predicting content popularity, the method (600) executable by a server, the server coupled to a communication network (110), the communication network (110) having coupled thereto a search engine server (118) and a content hosting server (114), the method (600) comprising:

a. receiving (602), from a crawler database (126), an indication (136) of a content item (206) hosted in a content hosting web resource (204);

b. receiving (604), from a logs (128), the logs comprising a search log (130) and a browsing log (132), a search logs data (138) and a browsing logs data (138), the search logs data (138) representing search activity from one or more users of the search engine server (118) directed to the content item (206), and the browsing logs data (138) representing browsing activity from one or more users of a browser application (103) directed to the content item (206);

c. receiving (606), from the crawler database (126), a statistical web data (137) representing at least one of embeds (308) or links (306) of one or more web resources (124) directed to the content item (206); and

d. predicting (608) a content popularity, based at least in part of (i) the search logs data (138); (ii) the browsing logs data (138); and (iii) the statistical web data (137).

CLAUSE 2. The method of clause 1, further comprising:
receiving, from the content hosting server (114) via a content hosting service API (116), a listing of statistical data associated with the static and dynamic features (140) of the content item, the (i) static features comprising features descriptive of the content item (206) that remains independent of user views, and the (ii) dynamic features comprising features descriptive of the content item (206) that captures the relationship between the content item (206) and the user interactions;
and wherein the predicting comprises:
predicting the content popularity, based at least in part of (i) the search logs data (138); (ii) the browsing logs data (138); (iii) the statistical web data (137), and (iv) the static and dynamic features (140) received via the content hosting service API (116).

CLAUSE 3. The method of any one of clauses 1 and 2, wherein the server is implemented as part of the search engine server (118).

CLAUSE 4. The method of any one of clauses 1 and 2, wherein the search logs (130) is implemented as part of the search engine server (118).

CLAUSE 5. The method of any one of clauses 1 and 2, wherein the browsing logs (132) is implemented as part of the search engine server (118).

CLAUSE 6. The method of any one of clauses 1 to 5, wherein the content hosting server (114) storing the content hosting web resource (204) hosting the content item (206) has been previously crawled, and the indication of the crawled content hosting web resource (204) being stored in the crawler database (126).

CLAUSE 7. The method of any one of clauses 1 to 6, wherein the statistical web data (137) representing at least one of embeds (308) or links (306) of the content item (206) contained in one or more web resources (124) has been previously crawled from the web resource server (122) and stored in the crawler database (126).

CLAUSE 8. The method of any one of clauses 1 to 7, wherein the search logs data (138) includes dynamic-search-logs-features associated with the content item (206), the dynamic-search-logs-features comprising at least one of:
a number of shows of a content item (206) URL on a search engine result page (SERP);
a number of clicks on the content item (206) URL on the SERP; and,
a click through rate of the content item (206) URL on the SERP.

CLAUSE 9. The method of any one of clauses 1 to 8, wherein the browsing logs data (138) includes dynamic-browsing-logs-features associated with the content item (206), the dynamic-browsing-logs-features comprising a number of visits of the content item (206) URL registered in the browsing logs (132).

CLAUSE 10. The method of any one of clauses 1 to 9, wherein the statistical web data (137) representing at least one of embeds (308) or links (306) of the content item (206) contained in one or more web resources (124) include aggregated-dynamic-web-features associated with the content item (206), the aggregated-dynamic-web-features including at least one of:
a number of all embeds (308) of the content item (206);
a number of all hosts with embeds (308) of the content item (206);
a maximum number of embeds (308) of the content item (206) per host;
an average number of embeds (308) of the content item (206) per host;
a maximum number of embeds (308) of content item (206) per page;
an average number of embeds (308) of content item (206) per page;
a number of days passed since the first embed (308) of the content item (206);
a number of days passed since the last embed (308) of the content item (206);
an average number of days passed since any embed (308) of the content item (206);
a number of all links (306) to the content item (206);
a number of all hosts with links (306) to the content item (206);
a maximum number of links (306) to the content item (206) per host;
an average number of links (306) to the content item (206) per host;
a number of days passed since the day of the day of a first link (306);
a number of days passed since the content item (206) was linked last time; and,
an average number of days passed since there was any link (306) to the content item (206).

CLAUSE 11. The method of any one of clauses 1 to 6, wherein the statistical web data (137) representing at least one of embeds (308) or links (306) of the content item (206) contained in one or more web resources (124) include non-aggregated-dynamic-web-features associated with the content item (206), the non-aggregated-dynamic-web-features including at least one of:
a host list with embed (308) timestamps of the content item (206); and
a host list with link (306) timestamps of the content item (206).

CLAUSE 12. The method of any one of clauses 1 to 11, wherein the predicting of content popularity is executed using a machine learning algorithm.

CLAUSE 13. The method of clause 12, wherein the machine learning algorithm is using a Friedman's gradient boosting decision trees model.

CLAUSE 14. The method of clause 13, wherein the Friedman's gradient boosting decision trees model is receiving an outcome of a linear influence model as an input feature.

CLAUSE 15. The method of clause 14, wherein the linear influence model is receiving a non-aggregated-dynamic-web-feature as an input feature.

CLAUSE 16. The method of clause 13, further comprising training the machine learning algorithm.

CLAUSE 17. The method of clause 16, wherein the training of the machine learning algorithm is executed continuously in parallel with the prediction of content popularity.

CLAUSE 18. The method of any one of clauses 1 to 17, further comprising ranking the content item (206) based on the determined content popularity prediction.

CLAUSE 19. A server coupled to a communication network (110), the communication network (110) having coupled thereto a search engine server (118) and a content hosting server (114), the server comprising:

a. a communication interface configured to communicate with the search engine server (118) via a communication network (110);

b. at least one computer processor operationally connected with a communication interface, configured to:
i. receive, from a crawler database (126), an indication (136) of a content item (206) hosted in a content hosting web resource (204);
ii. receive, from a logs (128), the logs comprising a search log (130) and a browsing log (132), a search logs data (138) and a browsing logs data (138), the search logs data (138) represents search activity from one or more users of the search engine server (118) directed to the content item (206), and the browsing logs data (138) represents browsing activity from one or more users of a browser application (103) directed to the content item (206);
iii. receive, from the crawler database (126), a statistical web data (137) representing at least one of embeds (308) or links (306) of one or more web resources (124) directed to the content item (206); and
iv. predict a content popularity, based at least in part of (i) the search logs data (138); (ii) the browsing logs data (138); and (iii) the statistical web data (137).

CLAUSE 20. The server of clause 19, the processor being further configured to:

receive, from the content hosting server (114) via a content hosting service API (116), a listing of statistical data associated with the static and dynamic features (140) of the content item, the (i) static features comprising features descriptive of the content item (206) that remains independent of user views, and the (ii) dynamic features comprising features descriptive of the content item (206) that captures the relationship between the content item (206) and the user interactions;

and to predict, the processor is configured to:

predict the content popularity, based at least in part of (i) the search logs data (138); (ii) the browsing logs data (138); (iii) the statistical web data (137), and (iv) the static and dynamic features (140) received via the content hosting service API (116).

CLAUSE 21. The server of any one of clauses 19 and 20, wherein the server is implemented as part of the search engine server (118).

CLAUSE 22. The server of any one of clauses 19 and 20, wherein the search logs (130) is implemented as part of the search engine server (118).

CLAUSE 23. The server of any one of clauses 19 and 20, wherein the browsing logs (132) is implemented as part of the search engine server (118).

CLAUSE 24. The server of any one of clauses 19 to 23, wherein the content hosting server (114) storing the content hosting web resource (204) hosting the content item (206) has been previously crawled, and the indication of the content hosting web resource (204) being stored in the crawler database (126).

CLAUSE 25. The server of any one of clauses 19 to 24, wherein the statistical web data (137) representing at least one of embeds (308) or links (306) of the content item (206) contained in one or more web resources (124) has been previously crawled from the web resource server (122) and stored in the crawler database (126).

CLAUSE 26. The server of any one of clauses 19 to 25, wherein the search logs data (138) includes dynamic-search-logs-features associated with the content item (206), the dynamic-search-logs-features comprising at least one of:
a number of shows of a content item (206) URL on a search engine result page (SERP);
a number of clicks on the content item (206) URL on the SERP; and,
a click through rate of the content item (206) URL on the SERP.

CLAUSE 27. The server of any one of clauses 19 to 26, wherein the browsing logs data (138) includes dynamic-browsing-logs-features associated with the content item (206), the dynamic-browsing-logs-features comprising a number of visits of the content item (206) URL registered in the browsing logs (132).

CLAUSE 28. The server of any one of clauses 19 to 27, wherein the statistical web data (137) representing at least one of embeds (308) or links (306) of the content item (206) contained in one or more web resources (124) include aggregated-dynamic-web-features associated with the content item (206), the aggregated-dynamic-web-features including at least one of:
a number of all embeds (308) of the content item (206);
a number of all hosts with embeds (308) of the content item (206);
a maximum number of embeds (308) of the content item (206) per host;
an average number of embeds (308) of the content item (206) per host;
a maximum number of embeds (308) of content item (206) per page;
an average number of embeds (308) of content item (206) per page;
a number of days passed since the first embed (308) of the content item (206);
a number of days passed since the last embed (308) of the content item (206);
an average number of days passed since any embed (308) of the content item (206);
a number of all links (306) to the content item (206);
a number of all hosts with links (306) to the content item (206);
a maximum number of links (306) to the content item (206) per host;
an average number of links (306) to the content item (206) per host;
a number of days passed since the day of the day of a first link (306);
a number of days passed since the content item (206) was linked last time; and,
an average number of days passed since there was any link (306) to the content item (206).

CLAUSE 29. The server of any one of clauses 19 to 24, wherein the statistical web data (137) representing at least one of embeds (308) or links (306) of the content item (206) contained in one or more web resources (124) include non-aggregated-dynamic-web-features associated with the content item (206), the non-aggregated-dynamic-web-features including at least one of:
a host list with embed (308) timestamps of the content item (206); and
a host list with link (306) timestamps of the content item (206).

CLAUSE 30. The server of any one of clauses 19 to 29, wherein the predicting of content popularity by the processor is executed using a machine learning algorithm.

CLAUSE 31. The server of clause 30, wherein the machine learning algorithm is using a Friedman's gradient boosting decision trees model.

CLAUSE 32. The server of clause 31, wherein the Friedman's gradient boosting decision trees model is receiving an outcome of a linear influence model as an input feature.

CLAUSE 33. The server of clause 32, wherein the linear influence model is receiving a non-aggregated-dynamic-web-feature as an input feature.

CLAUSE 34. The server of clause 31, further comprising training the machine learning algorithm.

CLAUSE 35. The server of clause 34, wherein the training of the machine learning algorithm is executed continuously in parallel with the prediction of content popularity.

CLAUSE 36. The server of any one of clauses 19 to 35, further comprising ranking the content item (206) based on the determined content popularity prediction.

1. A method for predicting content popularity, the method executable by a server, the server coupled to a communication network, the communication network having coupled thereto a search engine server and a content hosting server, the method comprising:
a. receiving, from a crawler database, an indication of a content item hosted in a content hosting web resource;
b. receiving, from a logs, the logs comprising a search log and a browsing log, a search logs data and a browsing logs data, the search logs data representing search activity from one or more users of the search engine server directed to the content item, and the browsing logs data representing browsing activity from one or more users of a browser application directed to the content item;
c. receiving, from the crawler database, a statistical web data representing at least one of embeds or links of one or more web resources directed to the content item; and
d. predicting a content popularity, based at least in part of (i) the search logs data; (ii) the browsing logs data; and (iii) the statistical web data.

2. The method of claim 1, further comprising:
receiving, from the content hosting server via a content hosting service API, a listing of statistical data associated with the static and dynamic features of the content item, the (i) static features comprising features descriptive of the content item that remains independent of user views, and the (ii) dynamic features comprising features descriptive of the content item that captures the relationship between the content item and the user interactions;
and wherein the predicting comprises:
predicting the content popularity, based at least in part of (i) the search logs data; (ii) the browsing logs data; (iii) the statistical web data, and (iv) the static and dynamic features received via the content hosting service API.

3. The method of claim 1, wherein the content hosting server storing the content hosting web resource hosting the content item has been previously crawled, and the indication of the crawled content hosting web resource being stored in the crawler database.

4. The method of claim 1, wherein the statistical web data representing at least one of embeds or links of the content item contained in one or more web resources has been previously crawled from the web resource server and stored in the crawler database.

5. The method of claim 1, wherein the search logs data includes dynamic-search-logs-features associated with the content item, the dynamic-search-logs-features comprising at least one of:
a number of shows of a content item URL on a search engine result page (SERP);
a number of clicks on the content item URL on the SERP; and,
a click through rate of the content item URL on the SERP.

6. The method of claim 1, wherein the browsing logs data includes dynamic-browsing-logs-features associated with the content item, the dynamic-browsing-logs-features comprising a number of visits of the content item URL registered in the browsing logs.

7. The method of claim 1, wherein the statistical web data representing at least one of embeds or links of the content item contained in one or more web resources include aggregated-dynamic-web-features associated with the content item, the aggregated-dynamic-web-features including at least one of:
a number of all embeds of the content item;
a number of all hosts with embeds of the content item;
a maximum number of embeds of the content item per host;
an average number of embeds of the content item per host;
a maximum number of embeds of content item per page;
an average number of embeds of content item per page;
a number of days passed since the first embed of the content item;
a number of days passed since the last embed of the content item;
an average number of days passed since any embed of the content item;
a number of all links to the content item;
a number of all hosts with links to the content item;
a maximum number of links to the content item per host;
an average number of links to the content item per host;
a number of days passed since the day of the day of a first link;
a number of days passed since the content item was linked last time; and,
an average number of days passed since there was any link to the content item.

8. The method of claim 1, wherein the statistical web data representing at least one of embeds or links of the content item contained in one or more web resources include non-aggregated-dynamic-web-features associated with the content item, the non-aggregated-dynamic-web-features including at least one of:
a host list with embed timestamps of the content item; and
a host list with link timestamps of the content item.

9. The method of claim 1, wherein the predicting of content popularity is executed using a machine learning algorithm; and wherein the machine learning algorithm is using a Friedman's gradient boosting decision trees model; and wherein the Friedman's gradient boosting decision trees model is receiving an outcome of a linear influence model as an input feature.

10. The method of claim 9, wherein the linear influence model is receiving a non-aggregated-dynamic-web-feature as an input feature.

11. A server coupled to a communication network, the communication network having coupled thereto a search engine server and a content hosting server, the server comprising:
a. a communication interface configured to communicate with the search engine server via a communication network;
b. at least one computer processor operationally connected with a communication interface, configured to:
i. receive, from a crawler database, an indication of a content item hosted in a content hosting web resource;
ii. receive, from a logs, the logs comprising a search log and a browsing log, a search logs data and a browsing logs data, the search logs data represents search activity from one or more users of the search engine server directed to the content item, and the browsing logs data represents browsing activity from one or more users of a browser application directed to the content item;
iii. receive, from the crawler database, a statistical web data representing at least one of embeds or links of one or more web resources directed to the content item;
iv. predict a content popularity, based at least in part of (i) the search logs data; (ii) the browsing logs data; and (iii) the statistical web data.

12. The server of claim 11, the processor being further configured to:
receive, from the content hosting server via a content hosting service API, a listing of statistical data associated with the static and dynamic features of the content item, the (i) static features comprising features descriptive of the content item that remains independent of user views, and the (ii) dynamic features comprising features descriptive of the content item that captures the relationship between the content item and the user interactions;
and to predict, the processor is configured to:
predict the content popularity, based at least in part of (i) the search logs data; (ii) the browsing logs data; (iii) the statistical web data, and (iv) the static and dynamic features received via the content hosting service API.

13. The server of claim 11, wherein the content hosting server storing the content hosting web resource hosting the content item has been previously crawled, and the indication of the content hosting web resource being stored in the crawler database.

14. The server of claim 11, wherein the statistical web data representing at least one of embeds or links of the content item contained in one or more web resources has been previously crawled from the web resource server and stored in the crawler database.

15. The server of claim 11, wherein the search logs data includes dynamic-search-logs-features associated with the content item, the dynamic-search-logs-features comprising at least one of:
a number of shows of a content item URL on a search engine result page (SERP);
a number of clicks on the content item URL on the SERP; and,
a click through rate of the content item URL on the SERP.

16. The server of claim 11, wherein the browsing logs data includes dynamic-browsing-logs-features associated with the content item, the dynamic-browsing-logs-features comprising a number of visits of the content item URL registered in the browsing logs.

17. The server of claim 11, wherein the statistical web data representing at least one of embeds or links of the content item contained in one or more web resources include aggregated-dynamic-web-features associated with the content item, the aggregated-dynamic-web-features including at least one of:
a number of all embeds of the content item;
a number of all hosts with embeds of the content item;
a maximum number of embeds of the content item per host;
an average number of embeds of the content item per host;
a maximum number of embeds of content item per page;
an average number of embeds of content item per page;
a number of days passed since the first embed of the content item;
a number of days passed since the last embed of the content item;
an average number of days passed since any embed of the content item;
a number of all links to the content item;
a number of all hosts with links to the content item;
a maximum number of links to the content item per host;
an average number of links to the content item per host;
a number of days passed since the day of the day of a first link;
a number of days passed since the content item was linked last time; and,
an average number of days passed since there was any link to the content item.

18. The server of claim 11, wherein the statistical web data representing at least one of embeds or links of the content item contained in one or more web resources include non-aggregated-dynamic-web-features associated with the content item, the non-aggregated-dynamic-web-features including at least one of:
a host list with embed timestamps of the content item; and
a host list with link timestamps of the content item.

19. The server of claim 11, wherein the predicting of content popularity by the processor is executed using a machine learning algorithm; and wherein the machine learning algorithm is using a Friedman's gradient boosting decision trees model; and wherein the Friedman's gradient boosting decision trees model is receiving an outcome of a linear influence model as an input feature.

20. The server of claim 19, wherein the linear influence model is receiving a non-aggregated-dynamic-web-feature as an input feature.
